(19) United States
(12) Patent Application Publication
(10) Pub. No.: US 2008/0238893 A1
(43) Pub. Date: Oct. 2, 2008

(54) IMAGE CAPTURE APPARATUS WIRELESS DISPLAY

(76) Inventor: Kensuke Ishii, San Diego, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 11/692,748

(22) Filed: Mar. 28, 2007

(51) Int. Cl. H04N 5/222

(52) U.S. Cl. 345/204

(57) ABSTRACT

A wireless display module for an image capture device, comprises a housing, a display element disposed on the housing, a wireless communications interface coupled to the display element, and an attachment mechanism disposed on the housing and configured to releasably attach the display module to the image capture device. In one embodiment, the display is removable from the image capture device and the wireless interface provides image transfer between the image capture device and the display to enable the display to be operated as either an integral or separate component of the image capture device.

### TECHNICAL FIELD

The present invention relates to displays, and more particularly, some embodiments relate to wireless displays for an image capture devices.

### DESCRIPTION OF THE RELATED ART

Photography is derived from the Greek words photos, meaning light, and graphein, meaning to draw. It is widely believed that the word was first used by the scientist Sir John F. W. Herschel in 1839. Photography originally involved the recording of images as a result of light impinging on a photosensitive material. Early photographs were exposed as positives onto metal plates that had been sensitized to accept the image. Examples of such include Daguerreotypes, which were metal sheets upon which a positive silver image was made, and tintypes, in which a thin sheet of iron provided a base for light-sensitive material. It is William Henry Fox Talbot, however, that is often credited with inventing a process of capture the image on a negative, and using the negative to create prints. Eventually, photography evolved into a process by which the sensitized materials were coated on plate glass.

Perhaps the most significant historical advancement was in 1889, when George Eastman used a film comprised of emulsions coated on a flexible base. The flexibility this film meant that it could be rolled into a smaller package, enabling cameras to be made much smaller than was previously practical. This enabled small, cost effective cameras to be mass produced and available to the public in unprecedented volumes. Later, color films were introduced and made commercially viable.

Photography has evolved from its earliest forms into a variety of different photographic platforms. For example, other forms of radiation such as infrared, X-Ray or other radiation might be used to record images. As yet a further example of the evolution of photography, sequences of images can be captured and replayed as motion pictures. More recently, a major advancement of photography has been the commercialization of digital still and motion photography. With digital cameras, light sensitive semiconductor devices, such as charge-coupled devices, are used to capture the image and processing technology is used to capture the image and store it in a memory or other storage device.

With advances in electronics, consumers have available to them a multitude of photographic and other image capture devices that were previously unavailable. Improvements in power consumption, storage densities, miniaturization and display technology, to name a few, have enabled rapid advances in image capture devices. Take, for instance, electronic content capture, storage, view and delivery devices such as, for example, digital cameras, digital video cameras and the like. Such devices are commonplace in contemporary society at the consumer, professional and prosumer level. Digital cameras, camera phones, video cameras and players, digital photo albums, and other image capture devices are seemingly ubiquitous.

With some image capture devices such as motion and image still cameras, the video display is a highly touted feature. Early devices had small, fixed displays that suffered from glare, resolution and other challenges. Anti-reflective coatings, glare shields and other mechanisms were introduce to enhance the operability of the displays. Eventually, pivoting and swiveling displays were offered that allowed the user greater flexibility of operation. With a pivoting or swiveling display on a camera, for example, the user can hold the camera at various orientations and angles and adjust the display for viewing. For example, a user can hold the camera above his or her head to get a shot over a crowd or other obstacle, and angle the display downward so the user can frame the shot. As another example, with video cameras, the user can swivel the display to face the subject. Such a feature might allow the user to be in the video and still view the frame during filming.

### BRIEF SUMMARY OF EMBODIMENTS OF THE INVENTION

According to various embodiments of the invention an image capture device, for recording, storing, transferring or displaying images can be provided with a body; an optical element disposed on the body; an image sensor coupled to the optical element; an image processor coupled to the image sensor; a wireless communications interface coupled to the image processor; and a display releasably mountable to the body of the image capture device and communicatively coupled to the wireless communications interface; wherein the display is removable from the body of the image capture device and the wireless interface provides image transfer between the image capture device and the display to enable the display to be operated as either an integral or separate component of the image capture device.

The image capture device might further be implemented to include a wired interface between the image processor and the display to allow communication of image data between the display and the image capture device when the display is mounted to the body of the image capture device.

Additionally, in one embodiment, the image capture device might be implemented such that the display also includes a rechargeable power source configured to power the display for remote operation. A power interface might be included between the body and the display to provide a signal from the image capture device to the rechargeable power source to charge the rechargeable power source. A hardwired interface might also be provided between the image processor and the display to allow communication of image data between the display and the image capture unit when the display is mounted to the body of the image capture unit.

In another embodiment, the image capture device might further be implemented such that the display also includes a user interface configured to allow the user to operate the image capture device from the display. In one embodiment, the image user interface might include, keys, buttons, or switches. In another embodiment, the image capture device also includes a touch-screen display panel.

In a further embodiment, the image capture device might further be implemented such that the display also includes a user interface configured to allow the user to operate the image capture device from the display; and a communication module configured to allow the display to communicate with the image capture device and with a host device.

In still another embodiment, the image capture device might further be implemented such that the body includes a mounting unit configured to accept the display in a plurality of orientations. In one embodiment, the display is configured to be releasably attached to the mounting unit either facing out from or facing toward the body.

A data interface module might also be provided to allow the device to operate in a first mode to provide communications with a PC and a second mode to provide communications with the display. The wireless interface might be an ultra-wideband or other communication interface. The image capture device might be, for example, a digital camera (still or video), a scanner, a printer, an electronic photo album, a camera phone, or other electronic device configured to operate with displayable content.

In a further embodiment, a wireless display module is provided for an image capture device, and might be configured to include a housing; a display element disposed on the housing; a wireless communications interface coupled to the display element; and an attachment mechanism disposed on the housing and configured to releasably attach the display module to the image capture device. In one embodiment, the display is removable from the image capture device, and the wireless interface provides image transfer between the image capture device and the display to enable the display to be operated as either an integral or separate component of the image capture device. A wired interface might also be included to allow communication of image data between the display and the image capture device when the display module is mounted to the body of the image capture device.

The display module might further include a rechargeable power source configured to power the display module for remote operation. A power interface might be provided between the image capture device and the display module to provide a signal from the image capture device to the rechargeable power source to charge the rechargeable power source.

In still another embodiment, the display module further includes a user interface configured to allow the user to operate the image capture device from the display. In one embodiment, the image user interface might include, keys, buttons, or switches. In another embodiment, the image capture device also includes a touch-screen display panel.

The display module might also be configured to include a mounting unit configured to allow the display to be mounted to the image capture device in a plurality of orientations. Further, the display might be configured to be releasably attach to the image capture device either facing out from or facing toward the image capture device.

A data interface module can be provided with the display module to operate in a first mode to provide communications with a PC and a second mode to provide communications with the display. The wireless interface might be an ultra-wideband or other communication interface. The image capture device might be, for example, a digital camera (still or video), a scanner, a printer, an electronic photo album, a camera phone, or other electronic device configured to operate with displayable content.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIG. 1 is a diagram illustrating an exemplary block diagram of an image capture device configured to include a removable display in accordance with one embodiment of the invention.

FIG. 2 is a block diagram illustrating one example configuration of a display module 124 in accordance with one embodiment of the invention.

FIG. 3 is a diagram illustrating one example of a display 124 docked with an image capture device 100 in accordance with one embodiment of the invention.

FIG. 4 is a diagram illustrating one example docking configuration in accordance with one embodiment of the invention.

FIG. 5 is a diagram illustrating an example of display module 124 in an undocked configuration with respect to image capture device 100.

FIG. 6 is a diagram illustrating an example of a wireless display module in an operation with a plurality of other electronic devices in accordance with one application of the invention.

FIG. 7 is a diagram illustrating an example computing module in accordance with one embodiment of the invention.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

The present invention is directed toward a system and method for a novel display for content delivery devices such as, for example, digital still and motion image cameras, and other electronics devices using displays. Particularly, in one embodiment, a detachable display panel can be provided with a wireless communications interface to allow the display to be removed from the image capture device. Such capability might be implemented, for example, to allow flexibility in capturing or viewing images with the device. In another embodiment, a wired communications interface and a power interface can be provided to allow operation of the display while physically attached to the device.

Before describing the invention in detail, it is useful to describe an example environment with which the invention can be implemented. One such example is that of a digital camera. In one example, a digital camera can include a series of optical elements (i.e., a lens) that is configured to focus light to create an image of a scene. With digital cameras, however, instead of focusing this light onto a conventional light sensitive film at the focal plane, the scene is focused onto a semiconductor image sensor, such as, for example, a CCD (charge coupled device) or CMOS (complementary metal oxide semiconductor) image sensor. The image sensor has several cells, corresponding to pixels, that respond electronically to the light focused thereon. In other words, the image sensors convert light into electrons. The accumulated charge for each cell is read out as an electrical signal, which, for a CCD, is converted into a digital pixel value in binary form. The CMOS signal is digital, so conversion is not necessary. The electrical signals created are clocked out of the sensor and processed into an image comprised of several digital pixels. The images can be stored locally in fixed or removable memory and later transferred to a computer or other external host.

Because a digital image is created and stored, it can also be displayed. This allows the photographer to view the image on a display after the photograph is taken. LCD display panels, for example, are commonplace on digital cameras and digital video cameras to allow image viewing. As such, electrical interfaces and drivers are provided to allow a preview of the image to be viewed as well as to display the exposed image stored in memory. Such displays might also provide a user interface for additional features such as displaying exposure characteristics, facilitating camera set up through menus or other like means, as well as displaying operational modes of the camera (for example, flash status, exposure compensation, focus mode, shutter/aperture settings and the like). Some cameras even use touch screen displays as a form of user interface to allow control and selections to be performed with a minimal use of buttons and switches. This is popular with some digital video cameras.

From time-to-time, the present invention is described herein in terms of this example environment. Description in terms of these environments is provided to allow the various features and embodiments of the invention to be portrayed in the context of an exemplary application. After reading this description, it will become apparent to one of ordinary skill in the art how the invention can be implemented in different and alternative environments beyond still and motion digital cameras.

The present invention is directed toward a system and method for a remote display for an electronic device such as, for example, a digital camera or other content capture device. In accordance with one or more embodiments of the invention, the remote display might include features such as, for example, a wireless interface to facilitate communication with the device when operated in a remote fashion; keys, buttons, switches, thumb wheels, d-pads, joysticks or other input devices to allow the entry of user data and commands; a power source, preferably rechargeable, for powering the display, including during remote operations; a hardwired interface to allow transfer of power and data during docked operations; and a display panel configured to display images as well as menus or other command information, and information about the content.

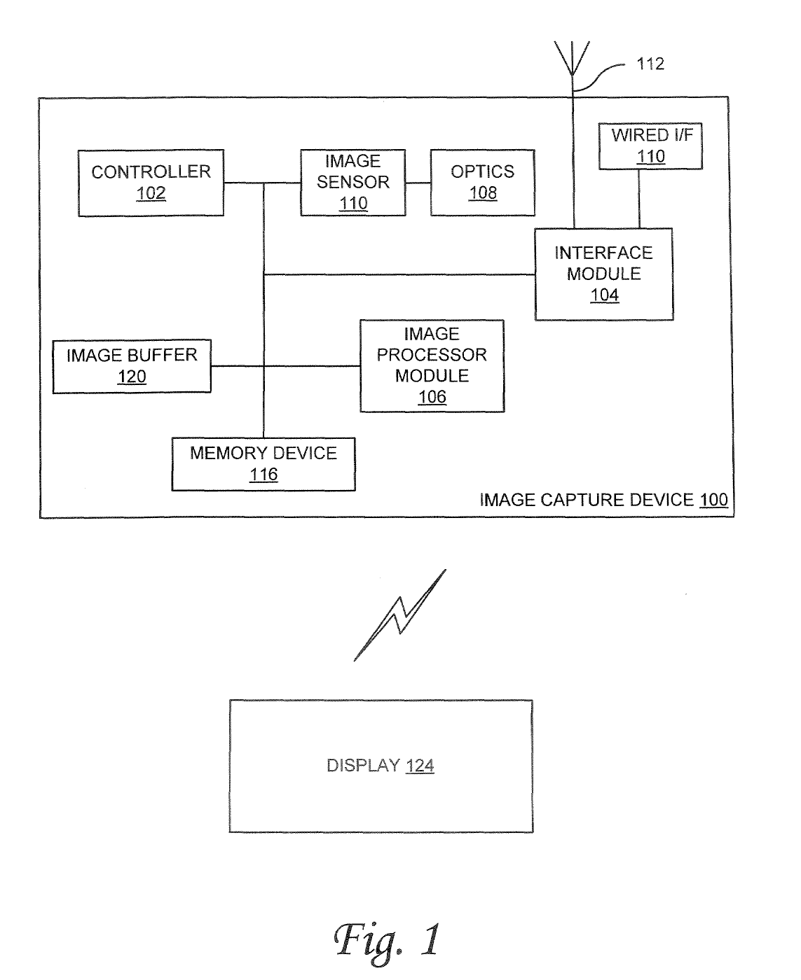

FIG. 1 is a diagram illustrating an exemplary block diagram of an image capture device configured to include a removable display in accordance with one embodiment of the invention. Referring now to FIG. 1, the example image capture device 100 illustrated includes a controller 102, a interface module 104, an image processing module 106, optics 108, an image sensor 114, a wireless interface 112, a hardwired interface 110, a memory or other storage device 116, a removable storage device 118, an image buffer 120, and a display 124. As noted, display 124 might be configured to be operated at locations remote from the main body of image capture device 100. Additionally, in one embodiment, display 124 might be configured to be dockable with image device 100 such that it can also be operated as an attached or interval piece of the main body of image capture device 100.

In the illustrated example implementation, image capture device 100 includes one or more optical elements 108 that can be used to capture a scene and focus the scene onto a focal plane. Optics 108 might typically include a plurality of optical elements that are configured to operate together to provide the ability to zoom into and out of the scene as well as to focus the scene onto the focal plane. Optical elements 108 can be implemented in a relatively simple fashion such as, for example, a fixed-aperture single-element lens, or a more complex structure such as a multi-element variable-aperture lens. Additionally, manual or auto focusing features can be provided.

As noted, optics 108 are typically used to focus a scene onto a focal plane. An image sensor 114 might be provided at the focal plane to receive the optical image and convert it into an electrical signal representative thereof. As discussed above in the description of an example environment, an image sensor 114 might be implemented as a CCD or CMOS image sensor, which is a semiconductor device configured to accept the light focused thereon and output an electrical representation of the optical image. Depending on the type of image sensor utilized, an analog-to-digital converter might be provided to divert the electrical signals to a digital format such that the image can be processed, for example, by an image processing module 106. Image sensors might be implemented to provide color data for color images.

An image processing module 106 can be included to process the digital image data to create a digital picture or digital rendition of the image captured. For example, image processing might include processing functions used to format the digital data into an appropriate image format, perform any desired image processing such as, for example, sharpening, smoothing, light balancing, and so on; performing image compression, and creating the appropriate image file format such as, for example, JPEG, TIFF and the like.

A processed image or a raw image file might be stored on a variety of storage devices such as, for example, a memory device 116 or a removable memory element 118. For example, various forms of internal and removable memory might be provided to facilitate local storage as well as removable storage. An example of removable memory might include, for example, a removable flash memory card. Also illustrated in the example of FIG. 1 is an image buffer 120 that might be provided to buffer the processed image for display on display 104. Image buffer might also be used to buffer for display preview images before a picture is actually taken. Memory device 116 might also store software or other processing functions used to process images or otherwise control the operation of image capture device 100. Additionally, memory device 116 might store menu screens and other like devices for display to the user during set up or configuration operations.

A controller 102 might be provided to control the various functions of the image capture device 100 as described herein. A controller 102 might be implemented utilizing various forms of control logic including, for example, processors, controllers, ASICs, PLAs, discrete logic and the like. For example, a controller 102 might control functions such as auto-focus functions, camera set-up functions, image transfer functions, and so on.

Also illustrated in the image capture device 100 of FIG. 1 is a interface module 104 that is communicatively coupled to a wired interface 110 and a wireless interface 112. Interface module 104 might be used for a variety of applications including providing a communications interface to display 124 in a docked or undocked configuration. Thus, for example, in an undocked or remote configuration, interface module 104 might provide a wireless communication interface between image capture device 100 and a remotely operating display 124. A variety of wireless communication protocols might be implemented to provide the interface depending on the operational environment anticipated. For example, the bandwidth required for transferring images, the desired range of operation, the desired speed of operation, and other like parameters may drive the choice of the wireless interface. In one example embodiment, wireless interfaces such as, for example, the WiMedia OFDM specification, Bluetooth, 802.11, and other interfaces might be utilized. In addition to these standards-based interfaces, proprietary interfaces might also be utilized.

Although illustrated as a separate, remote block in the example of FIG. 1, display 124 can also be operated in a docked configuration with image capture device 100. Therefore, in one embodiment, display 124 and image capture device 100 can be implemented to include the appropriate complementary docking facilities to allow docking and removal of display 124 with image capture device 100. For example, releasable connectors can be provided to allow display 124 to be removably attached to image capture device 100. Spring loaded or other like mechanisms can be used to provide a releasable attached mechanism. Keying type arrangements might also be used to ensure that display 124 is docked in a desired configuration. In one embodiment, display 124 might be docked or capable of being docked in a variety of configurations to allow the user to orient the display to his or her liking. Additionally, in one embodiment, the docking mechanism might include a pivotable, rotatable or otherwise movable element or elements such that a docked display can be tilted, rotated, or otherwise oriented while in a docked configuration.

Additionally, a docking mechanism might include appropriate hardwired interfaces to facilitate operation of display 124 separate from or complimentary with wireless interface 112. For example, a wired interface 110 might be used to facilitate faster image transfer or to accommodate higher bandwidth than wireless interface 112. Additionally, a wired interface might provide features such as power transfer to allow display 124 to be powered by a power source of image capture device 100. Such a configuration might also be configured to allow a power source of display 124 to be charged by a power source of image capture device 100 when docked or connected. As this example illustrates, a wired interface might be as simple as a pair of power connections to a powering or charging of the display, or might be configured to include additional connection for serial or parallel data communication.

As this example serves to illustrate, a removable display 124 might be implemented in an image capture device such as, for example, a digital camera to provide features and functionality not found in conventional image capture devices. As noted above, in discussion with the example environment, discussion of a removable display 124 in terms of an example image capture device 100 is done merely to provide a foundation on which to describe the myriad of features and functionality that might be provided with such a device. As one of ordinary skill in the art will appreciate, a removable or remote display 124 might be used in a variety of different capture devices each in a variety of different configurations.

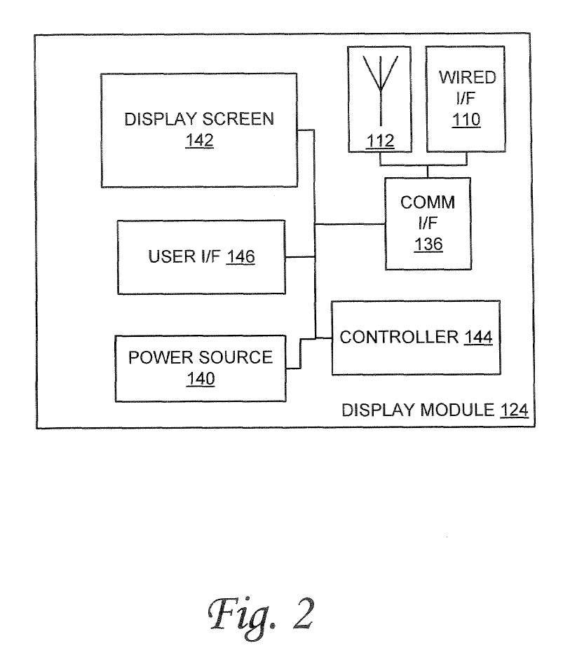

Having thus described an example application of a remote display 124 in an exemplary image capture device 100, an exemplary configuration of a display module 124 is now provided. FIG. 2 is a block diagram illustrating one example configuration of a display module 124 in accordance with one embodiment of the invention. Referring now to FIG. 2, this example implementation of a display module 124 is now described. The example illustrated in FIG. 2 includes a display screen 142, a display interface 146, a power source 140, a controller 144, a communications interface 136, and a wired and wireless communications interface 110, 112.

As discussed above, in one embodiment a display module can be configured to operate in a docked and an undocked configuration. In accordance with this embodiment, both a wired interface 110 and a wireless interface 112 might be provide to facilitate data communication between display module 124 and a host image capture device 100. A communications interface 136 might be provided to allow or manage the communication between display module 124 and a host image capture device 100. In operation, communication interface 136 might be configured to communicate various forms of data between display module 124 and image capture device 100. For example, as alluded to above, image previews or captured images gathered by image capture device 100 can be transmitted to display module 124 for display thereon. Accordingly, in a docked or remote configuration, image previews and captured images can be viewed by a user. Preferably, display module 124 is implemented in a way that is easy to locate and move around in the user's environment. In this vein, display module 124 might be physically configured with an appropriately shaped case or feet or other physical characteristics that allow positioning of the display for operation. Although not illustrated, handles, clips, and other features might be included to further facilitate the handleability, positionability or placement of display module 124.

Additionally, communications interface 136 might further be configured to allow display module 124 to communicate with other hosts in addition to an image capture device 100. Such other hosts might include, for example, a printer, computer, a scanner, or other device. For example, wired or wireless connectivity might be provided with a user's personal computer to facilitate the transfer of images or other information between display module 124 and the personal computer. In furtherance of this feature, memory or other storage might be provided with display module 124 (not illustrated in FIG. 2) to facilitate the local storage of images at display module 124. With such a configuration, locally stored images can be downloaded directly to a personal computer, printer or other device. As noted, such interface can be provided wired or wirelessly.

In one embodiment, a corresponding docking configuration can be provided with the printer, computer or other device to enable physical docking of display module 124 with these other devices. As a further extension, display module 124 might be configured to allow images to be previewed, zoomed, cropped, and so forth and to provide an image preview prior to image printing. As such, display module 124 might be configured to provide a user interface to a printer for selection, manipulation and printing of images.

Accordingly, in one embodiment, display module 124 can be configured to have the capability to interface with multiple devices to perform multiple features and functions. For example, a removable display module 124 might be configured to operate with a digital camera to preview and display captured images, to score captured images, and to download captured images to a personal computer, printer, or other device. Indeed, in another embodiment, image processing and other functions can be moved to or co-located on display module 124 to allow display module 124 to take on more of the functionality of the image capture device 100. As such, display module 124 might include image processing, image buffering, data storage, and other like features. As yet a further example, in one embodiment, image capture device 100 might be implemented as a “dumb” image capture device with all or almost all of the processing power and capabilities housed in display module 124. For example, image capture device 100 might simply be configured to include optics, image sensors and fundamental image formatting or processing and the remaining processing power and storage capabilities provided with display module 124. As such, display module might be a feature rich image capture and processing system that is interchangeable a number of different appliances.

Although not illustrated in FIG. 2, user interfaces can also be provided with a display module 124 to allow the user to manipulate the operations of display module 124. For example, buttons, switches, thumbwheels, D-pads, joysticks, and other devices or mechanisms can be utilized to allow the acceptance of user input or control. Additionally, display screen 142 might be implemented as a touch-screen display with various menu overlays to allow user interface and control. In one embodiment, a high degree of user interface and control can be provided to allow the user to operate the camera remotely utilizing display module 124.

Accordingly, in one embodiment, display module 124 might be implemented as a remote control to operate some or all of the functions of image capture device 100. As such, a two-way interface for remote control operations can be provided by way of communication interface 136. To further illustrate by way of example, user interface and control might be provided to allow the user to zoom and focus the camera, adjust camera settings, release the shutter, and review stored images.

Central to one embodiment of display module 124 is a display screen 142 that might be implemented to provide the features and functions typically found on an integrated display of a conventional image capture device. For example, a display screen 142 might be implemented to allow the user to view stored images, preview images prior to photographing, view menus and other setup information, and view configuration information. As noted above, in one embodiment, display screen 142 might be implemented as a touch-screen display to facilitate user input. In one embodiment, a display screen 142 is implemented as an LCD panel display although other display technologies can be utilized.

Also illustrated in the example of FIG. 2 are a power source 140 to provide power to various components of display module 124. Preferably, power source 140 is implemented as a lithium ion, NiCad, or other rechargeable power source to provide power to display module 124 during remote operations. As noted above, power source 140 might be charged via an interface with a host image capture device 100 or other host device. For example, wired or inductive contacts can be provided to furnish power pod of charging current to power source 140.

The illustrated embodiment, also illustrates a controller 144 provided to control the various operations of display module 124. The features and functions incorporated with display module 124 might typically drive the complexity of a controller 144. A controller 144 might be implemented using various forms of control logic including, for example, processors, controllers, ASICs, PLAs, or other logical elements.

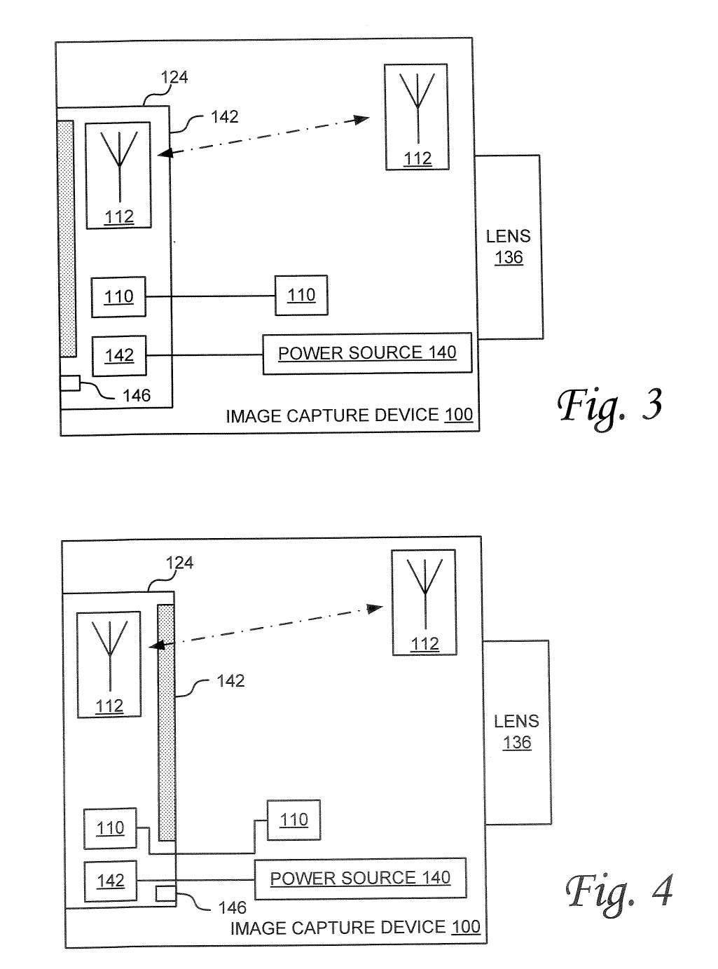

Having described suitable examples of a display module 124 and an image capture device 100 with which a display 124 might be implemented, various docked and undocked configurations are now described. FIG. 3 is a diagram illustrating one example of a display 124 docked with an image capture device 100 in accordance with one embodiment of the invention. Referring now to FIG. 3, in this example configuration, a display 124 is illustrated as being docked with an image capture device 100 at the rear of image capture device 100. FIG. 3 depicts a cut-away view so that the various components can be illustrated and described. As illustrated, a lens 136 is positioned at a first side of image capture device 100. Lens 136 might include, for example, optics 108 and other elements to enable a scene to be framed, focused, and image on to the focal plane.

In the illustrated embodiment, display module 124 is docked to the image capture device 100 at a position opposite lens 136, although other docking locations might be selected. In the example illustrated in FIG. 3, display 124 is docked in an orientation such that display screen 142 is facing in an outward direction from image capture device 100. Accordingly, display screen 142 is positioned such that it can be viewed by a user during operation of image capture device 100, even in a docked configuration. As illustrated by the example of FIG. 3, this configuration allows the image capture device 100 to be pointed at a scene in a conventional manner and allows the user to view display screen 142 as the scene is being framed, focused and photographed. Although illustrated in FIG. 3 as being mounted in a flush configuration with image capture device 100, other mounting configurations are also contemplated.

One or more user interfaces 146 are illustrated as being provided on the same face as display screen 142 to allow these interfaces to be utilized by the user to operate the display for camera functions. User interfaces 146 might also be provided at other locations. Such user interface 146 might be provided to operate in addition to or in place of various user interfaces that might otherwise be found on image capture device 100. Thus, for example, buttons or other controls to zoom, focus, set settings, activate shutter or perform other operations can be provided on display 124 in place of or in addition to mechanisms to provide similar functionality on image capture device 100. As will be appreciated by one of ordinary skill in the art, such functionality might be used to improve the overall design of image capture device 100. Additionally, the inclusion of such functionality with a display module 124 might also be utilized to provide greater controllability of image capture device 100 by a user operating display 124 remotely.

As also illustrated in FIG. 3, a power source 122 located in image capture device 100 might be included to provide power to display module 124 via a hardwired or inductive interface. This might be used to charge a power source 140 in display module 124 or to provide operational power to display module 124 during docked configurations. Also illustrated in FIG. 3 are the wired and wireless interfaces 110, 112 to provide image, data or other information exchange between image capture device 100 and display module 124. As illustrated, in a docked configuration, the interface can be provided by wired or wireless communication in one embodiment.

As noted above, in one embodiment, the docking mechanism is configured such that display module 124 can be mounted with image capture device 100 in a variety of orientations. Thus, display 124 might be configured to be mounted in a rotated configuration or might be mounted with a pivot or swivel type mounting mechanism to allow various ranges of motion. FIG. 4 is a diagram illustrating one example docking configuration in accordance with one embodiment of the invention. Referring now to FIG. 4 in this example configuration, display module 124 is mounted in a configuration such that display screen 142 is facing image capture device 100. This is different from the configuration illustrated in FIG. 3 where a display screen 142 was configured to face a user. This configuration might be desirable, for example, in situations where a user wishes to store or carry image capture device 100 and protect screen 142 from damage, fingerprints, or other elements.

Additionally, such a configuration might be desirable in embodiments where image capture device 100 includes its own dedicated screen in addition to screen 142 on the remote display module. Thus, a user may decide to dock display module 124 in such a configuration and utilize the standard monitor on image capture device 100. As one example, image capture device 100 might be configured to include a higher resolution, larger, or other display that might have additional features or characteristics as compared to display 142. For example, this might be done to allow full featured operation with image capture device 100 while providing a less feature-rich environment for display 142 for purposes such as power conservation, weight conservation, cost considerations, and so on. Thus, as this example configuration serves to illustrate, the various docking mechanisms can be provided to allow a plurality of orientations in a docked configuration.

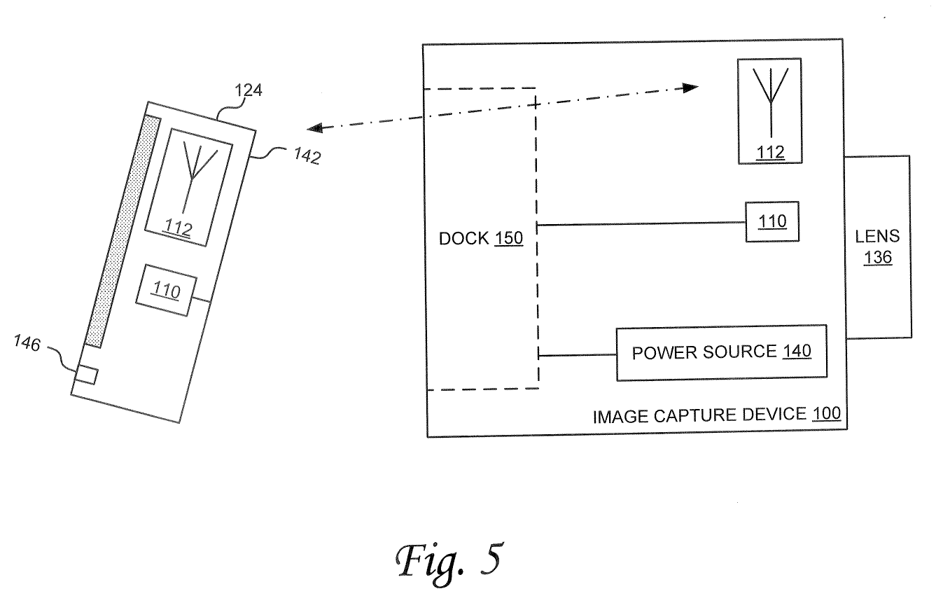

FIG. 5 is a diagram illustrating an example of display module 124 in an undocked configuration with respect to image capture device 100. Referring now to FIG. 5, display module 124 is illustrated as being remote from and wirelessly coupled to image capture device 100. In such a configuration, display module 124 might be configured such that it can be held by a user, carried to various locations by a user, or positioned on various surfaces to enable remote operation. As illustrated in FIG. 5, wireless interface 112 might be utilized to provide data sharing between image capture device 100 and display module 124. As described above, in this configuration, display module 124 might be configured to allow remote operation of image capture device 100 remote display of images and control information as well as other features. As also described above, an undocked display module 124 might also be configured for docking with other devices as well including, for example, printers, personal computers, work stations, digital photo albums, and other devices.

FIGS. 3, 4 and 5 depict simplified configurations of image capture device 100 and display module 124. As would be apparent to one of ordinary skill in the art, modules and architectures such as those illustrated in the examples provided in FIGS. 1 and 2 might be included in their respective image capture device 100 and display 124. However, one or ordinary skill in the art will also appreciate that other configurations can be utilized.

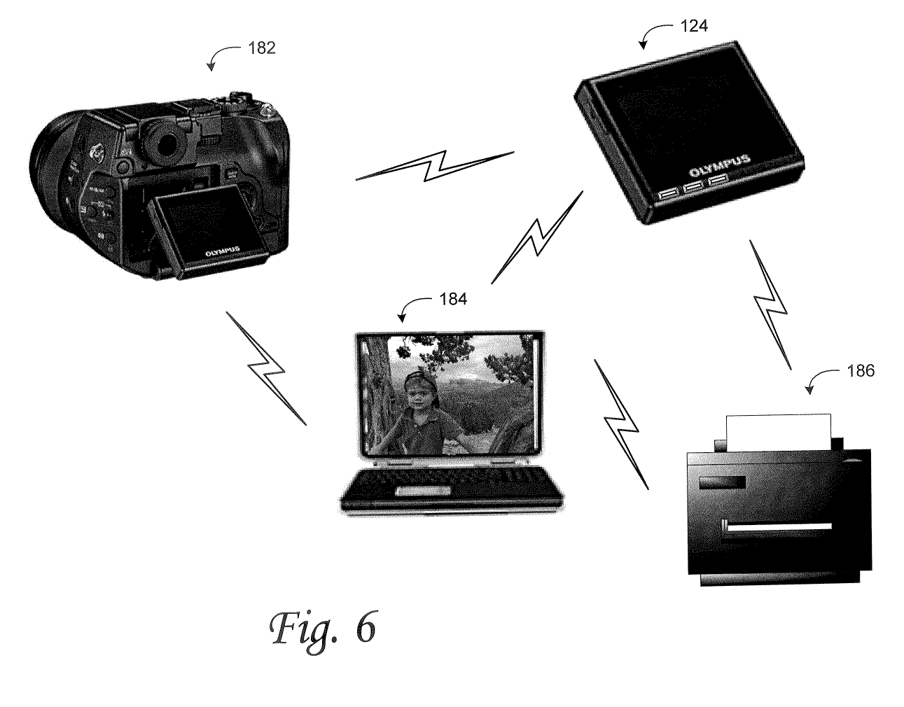

As described above, display module 124 can be utilized in a remote fashion to facilitate content capture, delivery, transport, and storage with a variety of devices. As further noted above, a display module 124 might be implemented such that it can communicate with a plurality of devices to further facilitate functionality and provide operational flexibility to a user. FIG. 6 is a diagram illustrating an example of a wireless display module in an operation with a plurality of other electronic devices in accordance with one application of the invention. Referring now to FIG. 6, this example operational environment includes a digital camera 182, a personal computer 184, a printer 186 and a display module 124, although other devices might be communicatively coupled as well. As illustrated, in this embodiment, display module 124 is configured to enable wireless communication among this plurality of devices. Thus, for example, display module 124 might be configured to communicate wirelessly with digital camera 182, personal computer 184, printer 186 and other devices.

Although not illustrated, these devices might each include a docking station 150 to allow display module 124 to be physically docked therewith. Also not illustrated is a cable or other hardwire interface that might be utilized to provide wired connectivity between display module 124 and the various devices. FIG. 6 is useful to describe features or capabilities that might be afforded by a display module 124 in such a configuration. For example, through the various controls 146 that might be provided in display module 124, a user might be given the ability to control the operation of digital camera 182 to perform function such as, for example, image preview, wireless shutter release, image review, camera control and so on. As described above, this can be accomplished for example via a wireless interface 112. Likewise, such controls might be used to allow a user to control printing of images or downloading of images to another device. For example, in one embodiment modes of operation are provided to allow the controls to operate camera functions, printer functions, and so on, depending on an operational state of the display 124. FIG. 6 also illustrates that remote display 124 might be used to wirelessly view images received from personal computer 184. For example, through the use of user interface controls 146, a user might be provided the ability to browse and view images or other content that might be stored on personal computer 184. This can be done is a wired or wireless fashion.

Additionally, as noted above, in embodiments where sufficient data storage might be provided with display module 124, images captured by digital camera might be transferred to the personal computer 184 or printer 186 via display module 124. Thus, for example, display module 124 can be used as a feature rich memory card or remote control to capture and store images and transfer them among various devices. This might be useful, for example, to allow a user to keep his or her camera body in the bag and use display module 124 to view images stored in the camera or in the display module or to transfer images from the camera or display module to various other devices such as a personal computer 184 or printer 186.

As FIG. 6 also illustrates, in one embodiment the various devices 182, 184, 186 might be provided with the capability to communicate with one another independent of or in addition to display module 124. Such independent communication allows data transfer between the devices to occur without having to be routed through a display module 124. Thus, for example, a conventional wireless or USB interface or other interface between a digital camera 182 and a personal computer 184 can be made to used to provide the image transfer.

In one embodiment, appropriate power management functions can be included to conserve power of battery operated devices. For example, automatic power on and power down features might be included to help manage power resources. As a further example, the wireless interface might be configured to automatically power down when display module 124 is placed in a docked configuration. This might be implemented to serve to reduce power consumption by both image capture device 100 and display module 124. As a further example, the communication unit might be configured to automatically power on and start communicating live images when a monitor is detached from image capture device 100. Such automatic power on might ease usability but might also consume more power. As such, a manual power on feature might be provided. In another embodiment, an image capture device 100 or display module 124 can be configured to operate in various modes to allow more automated operability. For example, display module 124 might be configured to automatically communicate with camera or other image capture device 100 in a shooting or image capture mode while also configured to automatically communicate with a personal computer, printer or other storage device in a data storage or data transfer mode. Likewise, an image capture device 100 or other devices in the “network” might also be configured to perform automatic configuration or communication depending on a mode selected. For example, interface module 104, as well as the image capture device itself, might be configured to operate in various modes depending on the device or devices with which image capture device 100 is operating. As a further example, it might be configured to operate in a device or client mode when operating with a PC, or in a host mode when communicating with a display.

As this further illustrates, the detachable monitor can be held by the user and placed in a variety of orientations and angles to allow easier shooting or operation of an image capture device 100. As noted above, a plurality of user or wireless interfaces can be provided to facilitate communications among the devices. As also noted in one embodiment, WiMedia or other ultra-wideband (UWB) technology might be utilized. ultra-wideband technology might be preferred in some environments because it has low power consumption, which will facilitate operation of the detachable monitor while working in a remote fashion with a dedicated battery. Additionally, an advantage of ultra-wideband technology is it facilitates high throughput to enable live image display. However, where other factors might be a consideration such as long-distance operation, other communication mechanisms might be preferred.

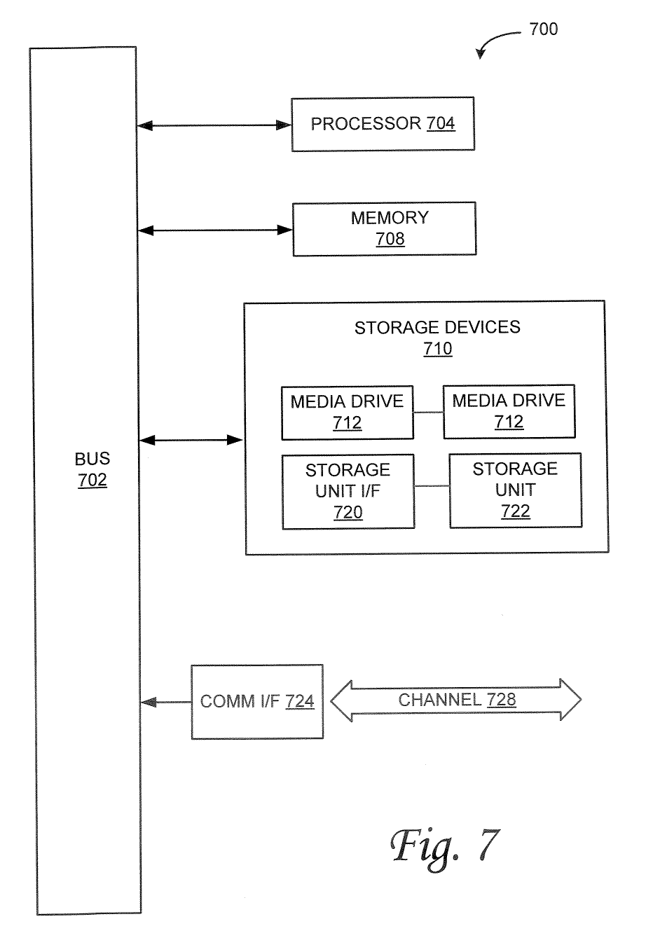

As used herein, the term module is used to describe a given unit of functionality that can be performed in accordance with one or more embodiments of the present invention. As used herein, a module might be implemented utilizing any form of hardware, software, or a combination thereof. For example, one or more processors, controllers, ASICs, PLAs, logical components or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the invention are implemented in whole or in part using software, in one embodiment, these software elements can be implemented to operate with a computing or processing module capable of carrying out the functionality described with respect thereto. One such example computing module is shown in FIG. 7. Various embodiments are described in terms of this example computing module 700. After reading this description, it will become apparent to a person skilled in the relevant art how to implement the invention using other computing modules or architectures.

Referring now to FIG. 7, computing module 700 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special or general purpose computing devices as may be desirable or appropriate for a given application or environment. Computing module 700 might also represent computing capabilities embedded within or otherwise available to a given device. For example, a computing module might be found in other electronic devices such as, for example, digital cameras, navigation systems, cellular telephones, modems, routers, WAPs, and any other electronic device that might include some form or processing capabilities.

Computing module 700 might include one or more processors or processing devices, such as a processor 704. Processor 704 might be implemented using a general-purpose or special-purpose processing engine such as, for example, a microprocessor, controller, or other control logic. In the example illustrated in FIG. 7, processor 704 is connected to a bus 702 or other communication medium to facilitate interaction with other components of computing module 700.

Computing module 700 might also include one or more memory modules, referred to as main memory 708. For example, preferably random access memory (RAM) or other dynamic memory, might be used for storing information and instructions to be executed by processor 704. Main memory 708 might also be used for storing temporary variables or other intermediate information during execution of instructions to be executed by processor 704. Computing module 700 might likewise include a read only memory (“ROM”) or other static storage device coupled to bus 702 for storing static information and instructions for processor 704.

The computing module 700 might also include one or more various forms of information storage mechanism 710, which might include, for example, a media drive 712 and a storage unit interface 720. The media drive 712 might include a drive or other mechanism to support fixed or removable storage media 714. For example, a hard disk drive, a floppy disk drive, a magnetic tape drive, an optical disk drive, a CD or DVD drive (R or RW), or other removable or fixed media drive. Accordingly, storage media 714, might include, for example, a hard disk, a floppy disk, magnetic tape, optical disk, a CD or DVD, or other fixed or removable medium that is read by, written to or accessed by media drive 712. As these examples illustrate, the storage media 714 can include a computer usable storage medium having stored therein particular computer software or data.

In alternative embodiments, information storage mechanism 710 might include other similar instrumentalities for allowing computer programs or other instructions or data to be loaded into computing module 700. Such instrumentalities might include, for example, a fixed or removable storage unit 722 and an interface 720. Examples of such storage units 722 and interfaces 720 can include a program cartridge and cartridge interface, a removable memory (for example, a flash memory or other removable memory module) and memory slot, a PCMCIA slot and card, and other fixed or removable storage units 722 and interfaces 720 that allow software and data to be transferred from the storage unit 722 to computing module 700.

Computing module 700 might also include a communications interface 724. Communications interface 724 might be used to allow software and data to be transferred between computing module 700 and external devices. Examples of communications interface 724 might include a modem or softmodem, a network interface (such as an Ethernet, network interface card, WiMedia, 802.XX or other interface), a communications port (such as for example, a USB port, IR port, RS232 port Bluetooth interface, or other port), or other communications interface. Software and data transferred via communications interface 724 might typically be carried on signals, which can be electronic, electromagnetic, optical or other signals capable of being exchanged by a given communications interface 724. These signals might be provided to communications interface 724 via a channel 728. This channel 728 might carry signals and might be implemented using a wired or wireless medium. Some examples of a channel might include a phone line, a cellular phone link, an RF link, an optical link, a network interface, a local or wide area network, and other wired or wireless communications channels.

In this document, the terms “computer program medium” and “computer usable medium” are used to generally refer to media such as, for example, memory 708, storage unit 720, media 714, and signals on channel 728. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 700 to perform features or functions of the present invention as discussed herein.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. An image capture device, comprising:
a body;
an optical element disposed on the body;
an image sensor coupled to the optical element;
an image processor coupled to the image sensor;
a wireless communications interface coupled to the image processor; and
a display releasably mountable to the body of the image capture device and communicatively coupled to the wireless communications interface;
wherein the display is removable from the body of the image capture device and the wireless interface provides image transfer between the image capture device and the display to enable the display to be operated as either an integral or separate component of the image capture device.

2. The image capture device of claim 1, wherein the display further comprises:
a user interface configured to allow the user to operate the image capture device from the display; and
a communication module configured to allow the display to communicate with the image capture device and with a host device.

3. The image capture device of claim 1, wherein the display further comprises a user interface configured to allow the user to operate the image capture device from the display.

4. The image capture device of claim 3, wherein the user interface comprises, keys, buttons, or switches.

5. The image capture device of claim 3, wherein the user interface comprises a touch-screen display panel.

6. The image capture device of claim 1, further comprising a wired interface between the image processor and the display to allow communication of image data between the display and the image capture device when the display is mounted to the body of the image capture device.

7. The image capture device of claim 1, wherein the display further comprises a rechargeable power source configured to power the display for remote operation.

8. The image capture device of claim 7, further comprising a power interface between the body and the display to provide a signal from the image capture device to the rechargeable power source to charge the rechargeable power source.

9. The image capture device of claim 1, further comprising a hardwired interface between the image processor and the display to allow communication of image data between the display and the image capture unit when the display is mounted to the body of the image capture unit.

10. The image capture device of claim 1, wherein the body comprises a mounting unit configured to accept the display in a plurality of orientations.

11. The image capture device of claim 10, wherein the display is configured to be releasably attached to the mounting unit either facing out from or facing toward the body.

12. The image capture device of claim 1, further comprising a data interface module configured to operate in a first mode to provide communications with a PC and a second mode to provide communications with the display.

13. The image capture device of claim 1, wherein the wireless interface is an ultra-wideband communication interface.

14. The image capture device of claim 1, wherein the image capture device is a digital camera.

15. A wireless display module for an image capture device, comprising:
a housing;
a display element disposed on the housing;
a wireless communications interface coupled to the display element; and
an attachment mechanism disposed on the housing and configured to releasably attach the display module to the image capture device.
wherein the display is removable from the image capture device and the wireless interface provides image transfer between the image capture device and the display to enable the display to be operated as either an integral or separate component of the image capture device.

16. The display module of claim 15, further comprising:
a user interface configured to allow the user to operate the image capture device from the display; and
a communication module configured to allow the display to communicate with the image capture device and with a host device.

17. The display module of claim 15, further comprising a wired interface to allow communication of image data between the display and the image capture device when the display module is mounted to the body of the image capture device.

18. The display module of claim 15, wherein the display module further comprises a rechargeable power source configured to power the display module for remote operation.

19. The display module of claim 18, further comprising a power interface between the image capture device and the display module to provide a signal from the image capture device to the rechargeable power source to charge the rechargeable power source.

20. The display module of claim 15, further comprising a wired interface to allow communication of image data between the display and the image capture unit when the display is mounted to the body of the image capture unit.

21. The display module of claim 15, wherein the display further comprises a user interface configured to allow the user to operate the image capture device from the display.

22. The display module of claim 21, wherein the user interface comprises, keys, buttons, or switches.

23. The display module of claim 21, wherein the user interface comprises a touch-screen display panel.

24. The display module of claim 15, wherein the module comprises a mounting unit configured to allow the display to be mounted to the image capture device in a plurality of orientations.

25. The display module of claim 24, wherein the display is configured to be releasably attached to the image capture device either facing out from or facing toward the image capture device.

26. The display module of claim 15, further comprising a data interface module configured to operate in a first mode to provide communications with a PC and a second mode to provide communications with the display.

27. The display module of claim 15, wherein the wireless interface is an ultra-wideband communication interface.

28. The display module of claim 15, wherein the image capture device is a digital camera.

29. An image capture device, comprising:
a wireless communications interface;
a display releasably mountable to a body of the image capture device and communicatively coupled to the wireless communications interface; and
a data interface module coupled to the communications interface and configured to operate in a first mode to provide communications with a host and a second mode to provide communications with the display;
wherein the display is removable from the body and the wireless interface provides image transfer to the display to enable the display to be operated as either an integral or separate component of the image capture device.
